(19) United States
(12) Patent Application Publication
(10) Pub. No.: US 2013/0290102 A1
(43) Pub. Date: Oct. 31, 2013

(54) Method of serving dynamic advertisement that changes as user approaches a business geo-location

(71) Applicant: Thien Van Pham, Lacey, WA (US)

(72) Inventor: Thien Van Pham, Lacey, WA (US)

(73) Assignee: Thien Van Pham, Lacey, WA (US)

(21) Appl. No.: 13/458,414

(22) Filed: Apr. 27, 2012

(51) Int. Cl. G06Q 30/02

(52) U.S. Cl. 705/14.57

(57) ABSTRACT

A method is provided for displaying dynamic advertisement based on the distance of a client to the physical business location. The method uses geo-location and user identifier to determine the appropriate ad content of an advertisement to present to the user.

### CROSS-REFERENCE TO RELATED APPLICATIONS

Not Applicable.

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates generally to mobile advertising using geo-location to determine what type of advertising to present to mobile users. Mobile advertising has been static and does not provide relevance or encourage mobile users to want products, services, or encourage users to visit the business promoting the advertisement.

The process of encouraging mobile users to take action upon receiving advertisements on their mobile device, such as an iPhone or Android Phone, has not been effectively done. What is missing from this mobile advertising process is the ability to dynamically change the advertisement as the user approaches the business using geo-location.

What is needed is a method for sending dynamic advertisements to users' devices based on their current geo-location from businesses who promoted the advertisements.

### BRIEF SUMMARY OF THE INVENTION

The invention comprises of two components, the client software for displaying the results of sending user's current geo-location and identity to the server software and the server software capable of matching the advertisement based on geo-location and user identity.

In a typical application, the user has a mobile device that runs the client software, such as an iPhone or an Android phone, approaches a business within a predefined proximity, the user will receive advertisements according to that business. As the user gets closer to the business, the advertisement dynamically changes based on the distance between the user and the business location. For example, if the user is between 1000 feet and 500 feet from the business, the user will receive an advertisement for a product. As the user gets closer to the business, say between 0 feet and 500 feet, the same advertisement for the same product changes to display something different, such as additional discount.

### BRIEF DESCRIPTION OF THE SEVERAL VIEWS OF THE DRAWING

FIG. 1 illustrates a general client server system setup.

FIG. 2 illustrates an advertisement that changes.

FIG. 3 illustrates a client approaching a business.

FIG. 4 illustrates an example table structure of a dynamic advertisement.

### DETAILED DESCRIPTIONS OF THE INVENTION

The invention is now described in detail with reference to a few embodiments thereof as illustrated in the accompanying drawings. In the following description, numerous specific details are set forth in order to provide thorough understanding of the present disclosure. It is apparent, however, to one skilled in the art, that the present discloser may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

A dynamic advertisement system comprises the business that wants to promote its products and/or services and the consumer who wants certain products and/or services. Typically, to become a user of a dynamic advertisement system, an entity, either human or non-human, registers for an account with the dynamic advertisement system. Thereafter, the registered user may log into the dynamic advertisement system via an account by providing, for example, a correct login ID or username and password. As used herein, a “user” may be an individual (human user), an entity (e.g., an enterprise business, business, or third party application), or a group (e.g., of individuals or entities) that interacts or communicates with or over such a dynamic advertisement environment.

When a user registers for an account with a dynamic advertisement system, the dynamic advertisement system may create and store a record, often referred to as a “user profile”, in connection with the user. The user profile may include information provided by the user and information gathered by various systems, including the dynamic advertisement system, relating to activities or actions of the user. For example, the user may provide his name, contact information, birth date, gender, preferences, and other demographical information to be included in his user profile.

The dynamic advertisement system may maintain a database of information relating to places. Places correspond to various physical locations, such as restaurants, hotels, coffee shops, and the like. Some places may correspond to larger regions that themselves contain places. Dynamic advertisement system may allow users to access information regarding each place using a client application (e.g., a browser) hosted by a wired or wireless station, such as a laptop, desktop or mobile device. For example, dynamic advertisement system may serve advertisement (or other structured documents) to users that request information about a place. The client application may automatically access Global Positioning System (GPS) or other geo-location functions supported by the mobile device and report the user's current location to the dynamic advertisement system.

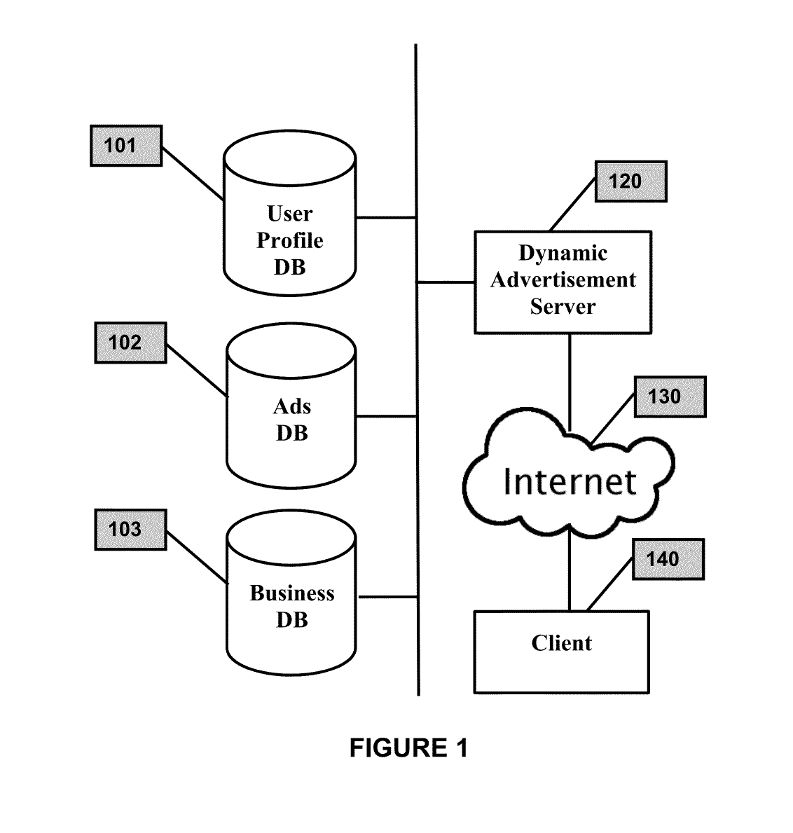

FIG. 1 illustrates an example dynamic advertisement system with location-based services and capabilities. In particular embodiments, the dynamic advertisement system may store user profile data in user profile database 101. In particular embodiments, the dynamic advertisement system may store user advertisement in the ads database 102. In particular embodiments, the dynamic advertisement system may store business data in the business database 103. In particular embodiments, databases 101, 102, and 103 may be operably connected to the dynamic advertisement server 120. In particular embodiments, the dynamic advertisement server 120 may interact with client 140 through the Internet 130. Client 140 is generally a computer or computing device including functionality for communicating (e.g., remotely) over a computer network. Client 140 may be a laptop computer, desktop computer, personal digital assistant, in- or out-of-car navigation system, smart phone or other cellular or mobile phone, or mobile gaming device, among other suitable computing devices. Client 140 may execute one or more client applications, such as a web browser (e.g., Microsoft Windows Internet Explorer, Mozilla Firefox, Apple Safari, and Google Chrome, etc.), to access and view content over a computer network. Dynamic advertisement server 120 may include web or HTTP server functionality, as well as other functionality to allow users to access the dynamic advertisement system. Internet 130 generally represents a network or collection of networks over which client 140 may access the dynamic advertisement system. In particular embodiments, business database 103 may store geo-location data identifying real-world geographic location of businesses.

In particular embodiments, client 140 sends geo-location data identifying its real-world geographic location to the dynamic advertisement server 120. For example, a geographic location of a business is a set of geographic coordinates (latitude and longitude).

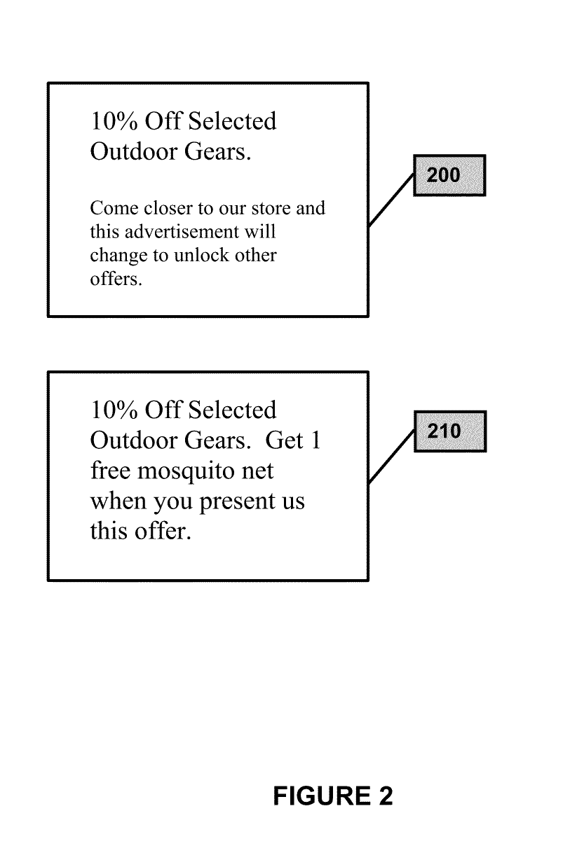

FIG. 2 illustrates how an advertisement may change from one form to another. In particular embodiments, advertisement 200 is the original advertisement that is display on client 140. In particular embodiments, advertisement 210 is an updated of the advertisement 200 when the user gets closer to the business. For example, if the user is between 1000 feet and 500 feet from the business offering the advertisement, advertisement 200 is display on client 140. When the user is within 500 feet from the business, the offer dynamically changes to advertisement 210.

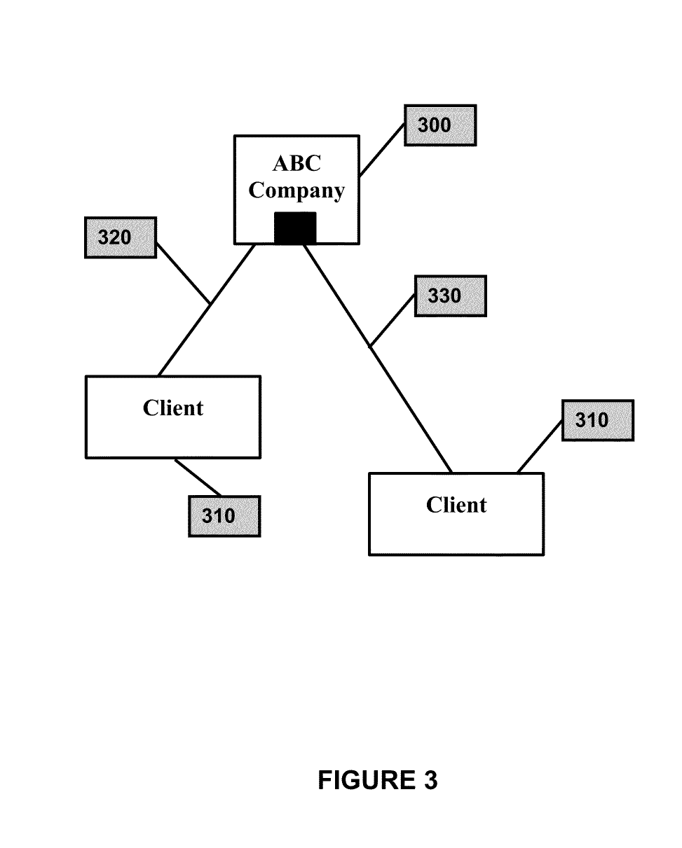

FIG. 3 illustrates a client approaching a business. In particular embodiments, ABC Company 300 is a business offering products and/or services with a geo-location representing the physical address of the business and is stored in the business database 103. ABC Company 300 advertisements may be stored in the ads database 102. In particular embodiments, client 310 is always connected to the Internet 130. Client 310 is generally a computer or computing device including functionality for communicating (e.g., remotely) over a computer network. Client 310 may be a laptop computer, desktop computer, personal digital assistant, in- or out-of-car navigation system, smart phone or other cellular or mobile phone, or mobile gaming device, among other suitable computing devices. Client 310 may execute one or more client applications, such as a web browser (e.g., Microsoft Windows Internet Explorer, Mozilla Firefox, Apple Safari, and Google Chrome, etc.), to access and view content over a computer network. In particular embodiments, client 310 may be at a distance 330 away from ABC Company 300. In particular embodiments, client 310 may move farther or closer to ABC Company 300. In particular embodiments, client 310 may come closer to ABC Company within distance 320. In particular embodiments, distance 330 is farther than distance 320. In particular embodiments, distance 320 and 330 is calculated using the geo-location of client 310 and ABC Company 300. A geo-location is a set of geographic coordinates (latitude and longitude). In the most general form, the distance between two geo-locations can be expressed using pseudo code:

ClientLat is a numeric value define as the latitude of the client

ClientLon is a numeric value define as the longitude of the client

ABCLat is a numeric value define as the latitude of ABC Company

ABCLon is a numeric value define as the longitude of ABC Company

DiffLat is define as a numeric value

DiffLon is define as a numeric value

Distance is define as a numeric value

DiffLat=ClientLat−ABCLat)*69.1

DiffLon=ClientLon−ABCLon)*53

Distance=ABS(SQRT(DiffLat̂ 2+DiffLon̂2))

SQRT is the standard mathematical square root function and ABS is the standard mathematical absolute value function.

For example, distance 330 is 1000 feet and distance 320 is 500 feet. When client 310 is anywhere between distance 330 and distance 320, client 310 sends a request along with its current geo-location and identity to dynamic advertisement server 120 through the Internet 130. Dynamic advertisement server 120 then responds to the request by first determining if client 310's current geo-location is within a defined range of an advertisement parameter set by ABC Company 300. If client 310's current geo-location meets the defined range requirement of the advertisement parameters set by ABC Company 300, then dynamic advertisement server 120 sends advertisement 200 to client 310. When client 310 is anywhere between 0 and distance 320 to ABC Company 300, client 310 sends a request along with its current geo-location and identity to dynamic advertisement server 120 through the Internet 130. Dynamic advertisement server 120 then responds to the request by first determining if client 310's current geo-location is within a defined range of an advertisement parameter set by ABC Company 300. If client 310's current geo-location meets the defined range requirement of the advertisement parameters set by ABC Company 300, then dynamic advertisement server sends advertisement 210 to client 310. Advertisement 200 and 210 are web pages. Client 310 may render a web page based on the HTML files from dynamic advertisement server 120 for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in Javascript, Java, Microsoft Silverlight, combinations of markup language and scripts such as Asynchronous Javascript and XML), and the like.

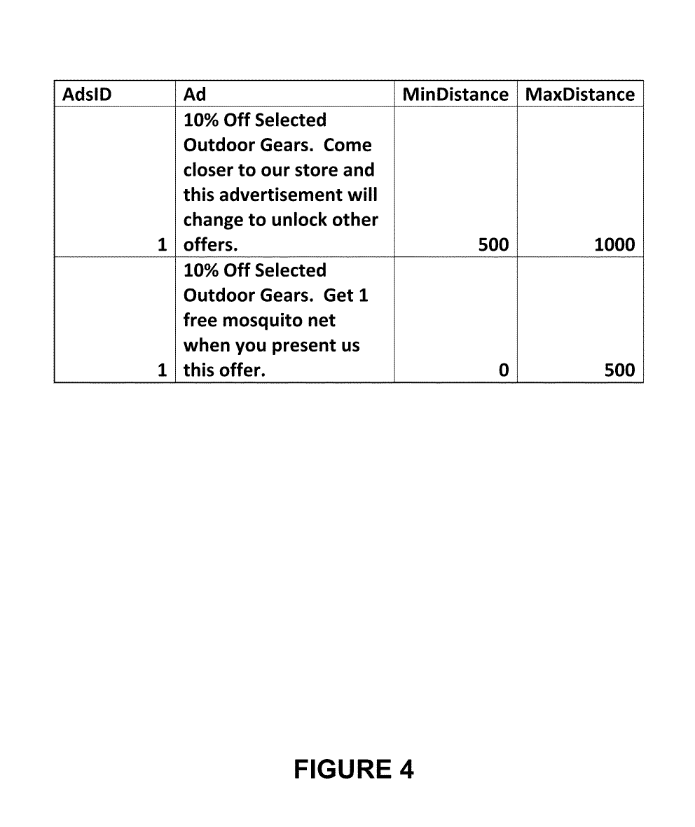

FIG. 4 illustrates an example table structure of a dynamic advertisement. In particular embodiments, an advertisement consists of rows of ad contents, minimal distances, and maximum distances. An advertisement's ad contents are served to the user according to how close they are to a business using geo-location.

What is claimed is:

1. A method whereby a client approaches a business within a set of distances and the advertisement dynamically changes according to the distance from the business.

2. The method of claim 1 wherein an advertisement contains multiple ad contents, minimum distances, and maximum distances.

3. The method of claim 2 whereby the client retrieves the ad content of an advertisement according to the client's distance that is between the minimum distance and maximum distance of the ad content.
